(19) United States
(12) Patent Application Publication
(10) Pub. No.: US 2025/0263015 A1
(43) Pub. Date: Aug. 21, 2025

(54) SAFE PASSING DISTANCE INDICATOR AND METHOD OF USING THE SAME

(71) Applicant: CCDS InvenTeam, LLC, Cincinnati, OH (US)

(72) Inventors: Jamie Back, Loveland, OH (US); Ashley Ward, Cincinnati, OH (US); Angela Barber-Joiner, Cincinnati, OH (US); Ayaan Arif, Mason, OH (US); Alex Back, Loveland, OH (US); Donovan Gray, Liberty Township, OH (US); Katerina Kranias, Cincinnati, OH (US); Lucia Murdoch, Cincinnati, OH (US); Ashley Odom, Liberty Township, OH (US); Kevin Pearson, Cincinnati, OH (US); Jason Starodub, Liberty Township, OH (US); Samantha Wu, Cincinnati, OH (US)

(21) Appl. No.: 19/056,422

(22) Filed: Feb. 18, 2025

Related U.S. Application Data
(60) Provisional application No. 63/555,277, filed on Feb. 19, 2024.

(51) Int. Cl. B60Q 9/00; B60K 35/28

(52) U.S. Cl. CPC B60Q 9/008; B60K 35/28

(57) ABSTRACT

The present disclosure teaches a system for enhancing the visibility and security of wheeled devices. The system may include a mountable housing unit containing a light projection system and an Artificial Intelligence (AI) detection system. The system may further include one or more line projection lights to project lighted line projections onto surfaces that the wheeled devices may be operating on. The light line projections may be placed at distances surrounding the wheeled device which indicate safe passing distances for any other wheeled devices attempting to pass the wheeled device utilizing the system. Additionally, the system may also include one or more sensors that collect sound and noise data for use within the AI detection system.

### CROSS REFERENCE TO RELATED APPLICATION

This application claims priority to U.S. Provisional Patent Application No. 63/555,277, filed on Feb. 19, 2024, which is incorporated by reference herein.

### TECHNICAL FIELD

Disclosed embodiments are directed to a system for wheeled devices such as bicycles and wheelchairs to enhance visibility and security of the users operating the wheeled devices and methods for using the same.

### BACKGROUND

Despite the increasing popularity of cycling, bicyclists face significant risks to their safety because of the car-centric nature of roads and lack of protected bike lanes. According to the Center for Disease Control and Prevention (2022), in the United States alone, about 130,000 are injured and about 1,000 are killed every year in bike accidents. Additionally, according to the National Safety Council (2022), the number of preventable deaths from biking incidents increased 44% between 2011 and 2020. This threat to cyclists' safety often stems from a lack of knowledge about bicyclist hand signals, state or local safe distance passing laws, and a general lack of visibility between cyclists and drivers.

Known bicycle safety systems may suggest general safe passing distance zones around a bicyclist, but do not demarcate the legal passing distance as prescribed by state or local laws. In addition, the lights displayed around the bicyclist are not visible during the daytime hours. Other safety systems do not integrate multiple safety measures such as directional turn signals, safety lights projected onto the ground, and features that detect approaching vehicles and notify the bicyclist of their presence.

However, known devices traditionally lack a component that incorporates the cyclist's awareness of the car's position. In other known devices, a lack of comprehensive safety is evident as they lack turn signals showing the cyclist's trajectory. Also, many known devices do not reflect local or state laws regarding legal passing distances of cyclists by motorists. Because of their non-holistic approach to safety, the threat posed to cyclists is still present even with features like a light to increase visibility for cyclists. Thus, a device that increases visibility is paramount to increase cyclists' safety.

### BRIEF DESCRIPTION OF THE DRAWINGS

Embodiments will be readily understood by the following detailed description in conjunction with the accompanying drawing. To facilitate this description, like reference numerals designate like structural elements. Embodiments are illustrated by way of example, and not by way of limitation, in the figure of the accompanying drawing.

FIG. 1 is a diagram showing a system of the present disclosure incorporated onto a bicycle.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

A comprehensive system for a bike safety device is disclosed which encompasses a myriad of features to enhance the visibility and security of users operating a wheeled device, such as bicyclists on a road. In one or more embodiments, the system includes an advanced safety feature including a laser or other light-based system that demarcates the legally required passing distance zone on the ground adjacent the bicycle such that vehicles passing the bicycle are aware of the zone they should not enter when passing the bicycle. In one or more embodiments, the system is adjustable to comply with state or local laws. The system incorporates turn signals strategically positioned at the back of the bike seat, which can be synchronized to flash with the demarcation zone projected onto the ground, ensuring maximum visibility for both cyclists and nearby motorists. In one or more embodiments, the system also includes an integrated rear light to further enhance the bike's visibility during various lighting conditions, including daylight, dawn, dusk, and night.

One contributing factor to cyclist vulnerability is the general lack of knowledge or adherence to safe passing distance laws. Many motorists are either unaware of, or fail to observe, the legally required distance that should be maintained when passing a cyclist, leading to dangerously close passes. While some existing bicycle safety systems attempt to outline a “safe zone” around the cyclist, these systems do not demarcate the legal passing distance specified by state or local laws. Additionally, these systems often lack visibility enhancements for daytime use, as their lights and signals may only be effective during nighttime or low-light conditions. This limitation reduces their overall utility and compromises safety during high-traffic daylight hours.

Another critical limitation in traditional bicycle safety devices is their failure to enhance the cyclist's situational awareness of nearby vehicles. Most current devices rely on passive visibility enhancements, such as static lights or reflective surfaces, which may not effectively communicate the presence of a cyclist to drivers. Some advanced vehicles may have detection systems to alert drivers to nearby bicycles, but these systems are not universal and provide limited protection for cyclists if the motorist's vehicle lacks such technology. Furthermore, even when detection systems are available, they may be hindered by environmental factors, such as poor lighting, or may not actively convey information about the cyclist's speed, position, or trajectory.

Another critical limitation in traditional bicycle safety devices is their failure to enhance the cyclist's situational awareness of nearby vehicles. Most current devices rely on passive visibility enhancements, such as static lights or reflective surfaces, which may not effectively communicate the presence of a cyclist to drivers. Some advanced vehicles may have detection systems to alert drivers to nearby bicycles, but these systems are not universal and provide limited protection for cyclists if the motorist's vehicle lacks such technology. Furthermore, even when detection systems are available, they may be hindered by environmental factors, such as poor lighting, or may not actively convey information about the cyclist's speed, position, or trajectory.

Additionally, many existing devices do not address the requirements set forth by local or state regulations regarding the legal passing distance for motor vehicles overtaking cyclists. This lack of regulatory compliance diminishes the effectiveness of these devices in ensuring a safe buffer between the cyclist and passing vehicles. Even devices with lane markers or static “safe zones” do not actively notify drivers when they have breached this zone, leaving cyclists vulnerable to close passes and potential collisions. Without an automated alert mechanism that can adapt to the presence of approaching vehicles, these systems offer limited utility in preventing accidents and safeguarding cyclists.

The enduring safety risks cyclists face underscore the need for a more comprehensive, integrated safety device that can provide cyclists with enhanced visibility, situational awareness, and a legally compliant safe passing indicator. Such a device should incorporate a variety of features, including visible, dynamic lighting that remains effective in daytime and nighttime conditions, projected safety zones around the cyclist, directional indicators, and a vehicle detection system that alerts both cyclists and drivers of potential hazards. Addressing these needs can improve the safety of cyclists and reduce the risk of collisions, thereby fostering a safer environment on shared roadways.

In one or more embodiments, the system may include an advanced safety feature that may include a laser or light-based system that may demarcate the legally required passing distance zone on the ground adjacent the bicycle such that vehicles passing the bicycle are aware of the zone they should not enter when passing the bicycle, which can be synchronized to flash with rear turn signals. Furthermore, the system may project light on the ground in front of the cyclist to signal to nearby vehicles the presence of the cyclist or to signify the presence of motor vehicles to the cyclist. In one or more embodiments, laser or light-based systems can be adjustable by the cyclist to adhere to diverse state and local laws.

In one or more embodiments, the system incorporates a bike-mounted artificial intelligence (AI) detection system equipped with microphones and sensors that can detect the presence of approaching vehicles. In one or more embodiments, the AI detection system may process audio and/or vibration signals and may classify them, alerting the bicyclist if nearby vehicles are detected. In one or more embodiments, the AI detection system may be designed to recognize and differentiate sounds produced by various manufacturers of electric vehicles as well as those generated by gasoline-powered or other motor vehicles. In one or more embodiments, to provide real-time warnings, the system can integrate with smartphones or other alert-providing systems, utilizing haptic feedback, blinking lights, and/or audible signals.

In one or more embodiments, the AI detection system can also be customized and connected via Bluetooth or other methods to seamlessly integrate with the overall safety system. In one or more embodiments, the system can also include a dedicated processing unit that controls the lights and the blinkers, while also communicating with the AI detection system. In one or more embodiments, the processing unit may also be connected to a smartphone, allowing for warnings to be issued directly to the cyclist. In one or more embodiments, the system may also include a versatile mounting system that can be easily attached to a bicycle or wheeled vehicle. In one or more embodiments, the system may be built into the bicycle or wheeled vehicle during the manufacturing process.

In one or more embodiments, the system can be powered by a battery system, which may also harness mechanical energy generated as the cyclist pedals the bicycle to recharge the batteries. This eco-friendly approach promotes a self-sustaining energy source for prolonged device functionality. The versatility of the system extends beyond bicycles, as it may also be mountable to or manufactured with medical assistive transportation devices such as wheelchairs, providing an inclusive safety solution.

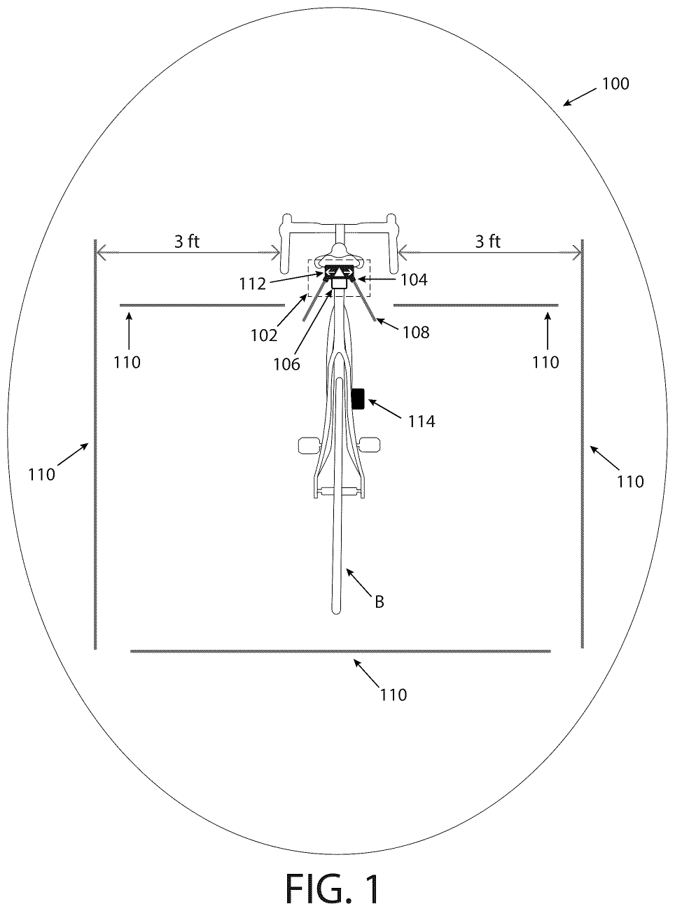

In one or more embodiments, a system 100 of the present disclosure may include a mountable housing unit 102. In one or more embodiments, mountable housing unit 102 may include a mounting system that may allow for unit 102 to be easily installed onto a rear seat or frame of a wheeled device, such as bicycle B shown in FIG. 1. In one or more embodiments, mountable housing unit 102 may contain a light projection system 104 and an artificial intelligence (AI) detection system 106. Although called out as separate systems, in one or more embodiments light projection system 104 and AI detection system 106 can be contained within one integral system.

In one or more embodiments, light projection system 104 may operate one or more line projection lights 108 which may produce one or more lighted line projections 110, surrounding bicycle B. Lighted line projections 110 may project light onto the surface surrounding the bicycle B. Lighted line projections 110 may be designed to lay out the legal safe passing distance per state or local laws. For example, in the state of Ohio, the legal safe passing distance is 3 feet, so lighted line projections 110 may project at a distance of three feet from the position of mountable housing unit 102 on bicycle B. In one or more embodiments, in addition to line projection lights 108, system 100 may also include a center mounted light 112. Center mounted light 112 may include turn signals and a centrally located light which may increase visibility of bicycle B. In one or more embodiments, light projection system 104 may synchronize lighted line projections 110 to blink when a turn signal is activated such that center mounted light 112 and line projection lights 108 may blink similar to a turn signal blinking in a motor vehicle.

In one or more embodiments, light projection system 104 may be customizable such that light projection system 104 may operate line projection lights 108 to project lighted line projections 110 that may be green, or another color. Lighted line lights 108 may be made and/or replaced with lasers, light-emitting diodes (LED), or other light producing devices. Lighted line projections 110 may also be made visible during any time of day and any weather conditions. As discussed above, in one embodiment, lighted line projections 110 may lie three feet away from bicycle B on either side or may be adjusted to other legally required state passing distances based on state or local laws. In one or more embodiments, lighted line projections 110 may need to be calibrated to lie at the correct distance for given state or local laws. In one or more embodiments, light projection system 104 may also produce lighted line projections 110 in front of and behind bicycle B, as well as any other location around bicycle B. In one or more embodiments, lighted line projections 110 may also be adjusted to make any shape, pattern, gradient, or type of line such as a zigzag or dotted line. In one or more embodiments, lighted line projections 110 may stay on all the time or may be made so that the user can disable line projection lights 108. In one or more embodiments, lighted line projections 110 may act in conjunction with any turn signals that come with a typical wheeled device, and lighted line projections 110 on the sides of bicycle B may be activated through a button, switch, or any other mechanism (not shown) that may be integrally connected with light projection system 104. In one or more embodiments, lighted line projections 110 may also be made to blink to indicate which direction the cyclist may be turning along with the turn signal lights of center mounted light 112. In one or more embodiments, the blinking of lighted line projections 110 on each side may be controlled independently or simultaneously.

In one or more embodiments, center mounted light 112 may include lights of any color, may be constantly illuminated, or may flash to indicate to drivers the presence of the cyclist. In one or more embodiments, center mounted light 112 may have the ability to be disabled by the user. In one or more embodiments, center mounted light 112 may be mounted using clamps, Velcro, zip ties, or any other method. In one or more embodiments, the intensity of center mounted light 112 and line projection lights 108 may also be of variable intensity, and the intensity of each may be adjusted independently by the user, or they may all be adjusted at once. As discussed above, center mounted light 112 may include turn signal lights in the shape of two arrows, with one pointing to the right and one pointing to the left. These lights can act as turn signals by having one arrow blink, indicating the direction that the cyclist will turn. The turn signals can be activated by the user, and they may be synchronized with the turn signals created by the blinking lines of line projection lights 108. In one or more embodiments, lights 108 and 112, and any other lights of system 100, may also act as hazard lights.

In one or more embodiments, system 100 will also include one or more microphones 114, that are mounted at various locations along the frame of bicycle B. In one or more embodiments, one or more microphones 114 may include a mounting system that may allow for one or more microphones 114 to be easily installed on the frame of the wheeled device, such as bicycle B. In one or more embodiments, one or more microphones 114 can be placed on the seat post, handlebars, within the skeleton of bicycle B, or manufactured into bicycle B. In one or more embodiments, one or more microphones 114 can be of any type suitable for capturing surrounding sounds, including omnidirectional or directional microphones depending on the desired scope of sound detection. In one or more embodiments, microphones 114 may collect data for use within AI detection system 106.

In one or more embodiments, AI detection system 106 may be trained to record, store, process, and categorize sounds to alert the user of a wheeled device, such as bicycle B, of nearby vehicles. Such sounds may include tire sounds, bicycle sounds, or any other such noise. In one or more embodiments, AI detection system 106 may utilize one or more processing units to assist in recording the sounds, executing AI system 106, and controlling light projection system 104. In one or more embodiments, the one or more processing units of AI detection system 106 may be used to record sounds using one or more microphones 114 discussed above. AI detection system 106 may continue to be updated after implementation to be able to categorize sound via the one or more processing units or via external software.

In one or more embodiments, AI detection system 106 may be trainable by the manual inputting of sounds and noise within a given category and once trained, AI detection system 106 may associate future sound and noise with that category. In one or more embodiments, sounds useable for training include tire noise, background noise, electric car stationary noise, engine noise, or any other such sound or noise. The live sound may be recorded using one or more microphones 114 or any other external microphone. When live sound is recorded by AI detection system 106, the AI model within AI detection system 106 may differentiate and categorize the sound based on its frequency or any other metric as it matches or fails to match the frequencies or alternate metrics of the stored data from training. This may be done on the one or more processing units of AI detection system 106 or via external software.

In one or more embodiments, after categorizing the data, AI detection system 106 may alert the user to the identity of the sound by projecting an auditory alert through one or more speakers (not shown). In one or more embodiments, the alerts may be sent via the one or more processing units of AI detection system 106 or via external software. In one or more embodiments, the alerts may additionally or only be sent to the user via a mobile device application, via a vibration sent to the handlebars or the seat of bicycle B, or via the activation of any of the lights operated by light projection system 104.

In one or more embodiments, system 100 may include mechanisms to enhance the safety of both the user and the surrounding environment. This may include an upper limit to the brightness of any of the lights operated by light projection system 104. Additionally, there may be a mechanism that automatically turns off any of the lights operated by light projection system 104. This may be engaged if housing 102 is improperly attached to the wheeled device or not attached to the wheeled device at all, or if the wheeled device is not in an upright position. In one or more embodiments, the turning off of any of the lights operated by light projection system 104 may occur through the user incorrectly attaching housing 102 or in the event of an accident.

In one or more embodiments, system 100 can be powered by a battery system (not shown), which may also harness mechanical energy generated as the wheels of the wheeled device are operated. This eco-friendly approach promotes a self-sustaining energy source for prolonged device functionality of system 100.

In one or more embodiments, AI detection system 106 may include an AI-based terrain recognition feature that analyzes the road or path ahead for potential hazards, such as potholes or uneven surfaces. In one or more embodiments, the AI-based terrain recognition feature may alert the cyclist to these hazards and suggests speed adjustments or alternate routes to enhance safety and comfort.

In one or more embodiments, the AI detection system 106 may connect to a cloud-based AI platform that collects real-time data from other cyclists, thereby offering dynamic route suggestions to help the user avoid traffic congestion, construction zones, or accidents. This feature may enable the cyclist to receive up-to-date information about road conditions and adjust their route accordingly.

In one or more embodiments, system 100 may incorporate a sensor-based adaptive control for lighted line projections 110, adjusting the light intensity and direction based on ambient lighting conditions and the proximity of approaching vehicles. This adjustment may optimize cyclist visibility without causing glare or discomfort to other road users.

In one or more embodiments, AI detection system 106 may feature vehicle identification that can recognize specific vehicle models and types such as trucks, motorcycles, or buses. Based on the identified vehicle type, AI detection system 106 may adjust the alert levels, giving the cyclist enhanced warnings if a higher-risk vehicle approaches.

In one or more embodiments, AI detection system 106 may include an AI monitoring component that analyzes driving patterns of nearby vehicles. This feature may predict potentially risky behaviors, such as sudden lane changes or aggressive driving, and may provide real-time alerts to the cyclist, allowing them to take preemptive safety measures.

In one or more embodiments, AI detection system 106 may integrate an AI emergency response component that may detect accidents based on sudden impacts or changes in movement. The AI emergency response component of AI detection system 106 may assess the severity of the incident and automatically contact emergency services, providing real-time location information and health data if connected to wearables.

In one or more embodiments, AI detection system 106 may feature real-time pedestrian recognition, detect pedestrians, and assess their movement patterns. AI detection system 106 may adjust lighting, sound, or provide verbal warnings to facilitate safe interactions with pedestrians, especially in crowded areas.

In one or more embodiments, AI detection system 106 may include an AI-powered networking feature that identifies nearby cyclists and offers group riding suggestions based on common destinations or potential safety in numbers. This feature may optimize routes and provide safety enhancements for group travel.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. An enhanced visibility and security system for wheeled devices comprising:
a light-based system comprising a light projection system including line projection lights that produce lighted line projections that demarcate a safety zone on a surface near a wheeled device such that vehicles passing the wheeled device are made aware of the safety zone.

2. The system of claim 1, wherein the safety zone is adjustable.

3. The system of claim 1, further comprising turn signals positioned at a rear of the wheeled device such that the turn signals are synchronizable with the safety zone.

4. The system of claim 1, wherein the light projection system further includes one or more lights which project visible light on a surface in front of the wheeled device, such that the one or more lights signal a presence of one or more potential hazards to a user of the wheeled device.

5. The system of claim 1, further comprising an Artificial Intelligence (AI) detection system comprising:
a processor; and
one or more sensors configured to detect a presence of one or more potential hazards.

6. The system of claim 5, wherein the processor is configured to:
classify signals collected by the one or more sensors;
determine if the signals suggest the presence of one or more potential hazards; and
provide one or more alerts to a user of the wheeled device if the signals suggest the presence of one or more potential hazards.

7. The system of claim 6, wherein the AI detection system further comprises one or more alert mechanisms to provide the one or more alerts.

8. The system of claim 6, wherein the AI detection system is configurable such that the one or more alerts may be presented to the user via a user device and one or more sensors comprises one or more microphones.

9. The system of claim 5, wherein the AI detection system further comprises an AI emergency response module configurable to detect accidents based on signals collected by the one or more sensors.

10. The system of claim 5, further comprising a mountable housing unit and wherein the light projection system and the AI detection system are housed within the mountable housing unit.

11. The system of claim 1, further comprising a battery system comprising a battery, wherein the battery system is configurable such that the battery system stores energy produced by one or more wheels of the wheeled device to charge the battery.

12. A method of enhancing visibility and security for wheeled devices comprising:
providing an enhanced visibility and security system, wherein the system includes a light-based system including a light projection system including line projection lights that produce lighted line projections; and
producing by the lighted line projections a safety zone on a surface near a wheeled device such that vehicles passing the wheeled device are made aware of the safety zone.

13. The method of claim 12, wherein the safety zone is adjustable.

14. The method of claim 12, further comprising synchronizing one or more turn signals positioned at a rear of the wheeled device with the safety zone.

15. The method of claim 12, wherein the light projection system further includes one or more lights which project visible light on the surface, the method further comprising projecting visible light from the one or more lights on a surface in front of the wheeled device such that the visible light provides a signal to a user of the wheeled device of a presence of one or more potential hazards.

16. The method of claim 12, further comprising detecting one or more potential hazards by an Artificial Intelligence (AI) detection system.

17. The method of claim 16, further comprising:
classifying signals collected by one or more sensors;
determining if the signals suggest one or more potential hazards; and
providing one or more alerts to a user of the wheeled device if the signals suggest one or more potential hazards.

18. The method of claim 17, wherein the AI detection system is configurable such that the one or more alerts may be presented to the user via a user device.

19. The method of claim 17, further comprising detecting accidents based on the collected signals from the one or more sensors.

20. The method of claim 12, further comprising charging a battery by storing energy produced by one or more wheels of the wheeled device.
